(19) United States
(12) Patent Application Publication
(10) Pub. No.: US 2025/0321202 A1
(43) Pub. Date: Oct. 16, 2025

(54) COMPONENT CONCENTRATION MEASUREMENT APPARATUS

(71) Applicant: HORIBA Advanced Techno, Co., Ltd., Kyoto (JP)

(72) Inventor: Takaaki TANAKA, Kyoto (JP)

(73) Assignee: HORIBA Advanced Techno, Co., Ltd., Kyoto (JP)

(21) Appl. No.: 19/169,532

(22) Filed: Apr. 3, 2025

(30) Foreign Application Priority Data
Apr. 11, 2024 (JP) 2024-064193

(51) Int. Cl. G01N 27/27; G01N 21/31

(52) U.S. Cl. CPC G01N 27/27; G01N 21/3103

(57) ABSTRACT

A component concentration measurement apparatus measures a concentration of a measurement target component in a chemical solution and includes a metal housing and a resin housing accommodated in the metal housing, in which an electrical device that drives an analysis device that analyzes the chemical solution is installed in the metal housing, and a pipe through which the chemical solution flows and the analysis device are installed in the resin housing.

### CROSS-REFERENCE TO RELATED APPLICATION

The present application claims priority under 35 U.S.C. § 119 to Japanese Patent Application No. 2024-064193, filed on Apr. 11, 2024. The above application is hereby expressly incorporated by reference, in its entirety, into the present application.

### BACKGROUND OF THE INVENTION

### 1. Technical Field

The present invention relates to a component concentration measurement apparatus that measures a component concentration in a chemical solution in a semiconductor manufacturing process or the like.

### 2. Description of the Related Art

Conventionally, as a component concentration measurement apparatus, for example, as illustrated in WO 2023/090111 A, there is an apparatus that is connected to a chemical solution pipe provided in a semiconductor manufacturing apparatus and measures a concentration and the like of a chemical solution (liquid sample) such as hydrofluoric acid (HF). This chemical solution concentration apparatus is configured such that a chemical solution pipe is passed through a housing, and optical measurement or electrochemical measurement can be performed on the chemical solution by using an analysis device installed in the housing.

### PRIOR ART DOCUMENT

### Patent Document

Patent Document 1: WO 2023/090111 A

### SUMMARY OF THE INVENTION

Apparatuses used in a semiconductor manufacturing process are required to conform to the Semiconductor Equipment and Materials International (SEMI) standard which is an international standard, and in particular, a component concentration measurement apparatus that treats a chemical solution as described above is required to ensure both chemical resistance and fire resistance.

In order to conform to the SEMI standard as described above, for example, it is conceivable to achieve both chemical resistance and fire resistance by using a flame-retardant PVC conforming to the FM4910 standard that determines flame retardant performance as a constituent material of a housing of the component concentration measurement apparatus. However, flame-retardant PVC is not preferable because of its unavailability, high material cost, and high manufacturing cost.

The present invention has been made to solve such a problem, and a main object of the present invention is to provide a component concentration measurement apparatus for a semiconductor manufacturing process capable of achieving both chemical resistance and fire resistance while suppressing a manufacturing cost.

A component concentration measurement apparatus of the present invention measures a concentration of a measurement target component in a chemical solution and includes a metal housing and a resin housing accommodated in the metal housing, in which an electrical device that drives an analysis device is installed in the metal housing, the analysis device analyzing the chemical solution, and a pipe through which the chemical solution flows and the analysis device are installed in the resin housing.

Such a configuration can satisfy the standard of flame retardancy required by the SEMI standard by installing, in a non-flammable metal housing, an electrical device that can cause ignition and a device (piping and analysis device) that treats a chemical solution such as an organic solvent. The resin housing having chemical resistance is accommodated in the metal housing, and the chemical solution pipe and the analysis device in which leakage of the chemical solution can occur are installed in the resin housing, and thus, the standard of chemical resistance can be satisfied.

Moreover, instead of satisfying the requirement for fire resistance and the requirement for chemical resistance by one housing, the requirement for fire resistance and the requirement for chemical resistance are satisfied by separate housings, a material cost can be suppressed and a manufacturing cost can be suppressed. That is, when both fire resistance and chemical resistance are to be satisfied by one resin housing, it is necessary to use expensive flame-retardant PVC. However, in the present invention, since the resin housing only needs to satisfy the requirement for chemical resistance, for example, inexpensive normal grade PVC can be used. It is therefore possible to satisfy both requirements of chemical resistance and fire resistance while suppressing the material cost and the manufacturing cost.

In the component concentration measurement apparatus, the electrical device is preferably provided inside the metal housing and outside the resin housing.

Such a configuration can prevent the chemical solution from scattering to the electrical device by spatially separating an area where the electrical device is installed and an area where the chemical solution is treated.

In the component concentration measurement apparatus, preferably, the metal housing and the resin housing each include an opening and closing door, and the opening and closing door of the resin housing is provided with a translucent region inside of which is visually recognizable.

In such a configuration, by providing a double opening and closing door for accessing the inside of the resin housing, a risk of the chemical solution being scattered to an operator can be reduced even when leakage occurs in the resin housing, and chemical resistance can be improved. In addition, since the opening and closing door of the resin housing has the translucent region, the operator can check the presence or absence of leakage of the chemical solution in the resin housing without opening the opening and closing door, and the risk of scattering of the chemical solution can be further reduced.

As an example of a specific aspect of the component concentration measurement apparatus, the opening and closing door of the resin housing includes a translucent resin material.

In the component concentration measurement apparatus, preferably, a protrusion protruding toward an outward surface of the opening and closing door of the resin housing is provided on an inward surface of the opening and closing door of the metal housing, and when the opening and closing door of the metal housing is closed, the opening and closing door of the resin housing is pressed in a closing direction by the protrusion.

In this way, by closing the opening and closing door as an outer door of the metal housing, the opening and closing door as an inner door of the resin housing can be closed. It is therefore possible to prevent the operator from forgetting to close the inner door and to further reduce a risk of leakage of the chemical solution.

Furthermore, the component concentration measurement apparatus preferably further includes a holding mechanism that holds the opening and closing door of the resin housing in a closed state.

In this way, when the opening and closing door of the metal housing is opened, it is possible to prevent the opening and closing door of the resin housing in the closed state from opening by itself.

In the component concentration measurement apparatus, the resin housing preferably includes a plurality of the opening and closing doors.

In such a configuration, when performing maintenance in the resin housing, the operator only needs to open only the opening and closing door corresponding to a necessary portion, and it is possible to reduce scattering of the chemical solution from a portion not related to a work area.

In the component concentration measurement apparatus, preferably, a fixing bracket is attached to an outer surface of the resin housing, and the resin housing is fixed to the metal housing via the fixing bracket.

In such a configuration, by connecting the fixing bracket attached to the resin housing and the metal housing, the metal housing can possess the strength of the resin housing, and the structure of the resin housing can be simplified.

In the component concentration measurement apparatus, an opening and closing door of the resin housing is preferably attached to the fixing bracket.

In such a configuration, the strength for supporting the opening and closing door of the resin housing can be possessed by the metal housing via the fixing bracket, and thus, the structure of the resin housing can be further simplified.

In the component concentration measurement apparatus, preferably, a support bracket provided with a tap hole is attached to the outer surface of the resin housing, a through hole is formed at a position corresponding to the tap hole on a side wall of the resin housing, and the analysis device disposed in the resin housing is screwed and supported in the tap hole of the support bracket.

In such a configuration, since the resin housing is not provided with a tap hole for screwing the analysis device, it is possible to suppress a decrease in the strength of the resin housing due to the formation of the tap hole. For example, the strength of the tap hole itself can be increased by providing a tap hole in a metal support bracket. In addition, since the support bracket is attached to the outside of the resin housing, corrosion due to scattering of the chemical solution can be prevented.

In the component concentration measurement apparatus, preferably, an inclined surface is formed on a bottom surface of the resin housing, and a drain port is formed in a lower region of the inclined surface.

In such a configuration, since the bottom surface (floor surface) of the resin housing is inclined and the drain port is formed in the lower region of the bottom surface, when leakage of the chemical solution occurs in the resin housing, the leakage can be automatically drained by gravity. It is therefore possible to prevent a situation in which the leakage overflows in the resin housing.

In the component concentration measurement apparatus, preferably, the inclined surface is formed all over the bottom surface, the inclined surface is provided with an attachment portion having an upper surface on which a horizontal attachment surface is formed, and a control valve that controls a flow rate of the chemical solution is attached to the horizontal attachment surface.

In such a configuration, a horizontal plane can be formed on the floor surface of the resin housing while ensuring drainability of leakage, and the flow rate of the chemical solution can be accurately controlled by attaching the control valve to such a horizontal plane.

The present invention described above can provide a component concentration measurement apparatus for a semiconductor manufacturing process capable of achieving both chemical resistance and fire resistance while suppressing a manufacturing cost.

### BRIEF DESCRIPTION OF THE DRAWINGS

FIG. 1 is a diagram illustrating an overall configuration of a component concentration measurement apparatus according to an embodiment of the present invention;

FIG. 2 is a diagram illustrating a configuration of the component concentration measurement apparatus according to the embodiment with an outer door opened;

FIG. 3 is a diagram illustrating a configuration of the component concentration measurement apparatus according to the embodiment with a resin housing taken out;

FIG. 4 is a front view illustrating a configuration of the component concentration measurement apparatus according to the embodiment with the outer door opened;

FIG. 5 is a perspective view of an internal configuration of the component concentration measurement apparatus according to the embodiment as viewed from a side;

FIG. 6 is a diagram illustrating an overall configuration of the resin housing according to the embodiment;

FIG. 7 is a diagram illustrating an overall configuration of a body of the resin housing according to the embodiment;

FIG. 8 is a front view illustrating a configuration of the resin housing according to the embodiment; and

FIG. 9 is a diagram illustrating an overall configuration of a bottom surface of the resin housing according to the embodiment.

### DETAILED DESCRIPTION

Hereinafter, a component concentration measurement apparatus 100 according to an embodiment of the present invention will be described with reference to the drawings.

The component concentration measurement apparatus 100 according to the present embodiment measures, for example, a concentration of a measurement target component contained in a chemical solution used in a semiconductor manufacturing apparatus. The component concentration measurement apparatus 100 is provided, for example, to be interposed in a chemical solution pipe for supplying a chemical solution, and measures a concentration of a measurement target component of the chemical solution. The concentration of the chemical solution and the like are controlled by using the concentration obtained in this manner. Examples of the chemical solution include, although not necessarily, ammonia hydrogen peroxide mixture (SC-1), hydrochloric acid hydrogen peroxide mixture (SC-2), sulfuric acid hydrogen peroxide mixture (SPM), hydrofluoric acid hydrogen peroxide mixture (FPM), and buffered hydrofluoric acid solution (BHF). The component concentration measurement apparatus 100 has fire resistance and chemical resistance conforming to the SEMI standard.

Specifically, the component concentration measurement apparatus 100 includes a chemical solution chamber S1 through which a pipe (chemical solution pipe) through which a chemical solution flows passes and in which one or a plurality of analysis devices 4 that analyzes the chemical solution is installed and an electrical chamber S2 in which an electrical device 3 is installed.

In the chemical solution chamber S1, an analysis device 4 for optical measurement that measures a light absorption spectrum of the chemical solution and an analysis device 4 for electrochemical measurement that electrochemically measures a characteristic of the chemical solution are installed as the analysis devices 4. As the analysis device 4 for optical measurement, an absorptiometer 41 that irradiates a chemical solution with light to measure absorbance is installed. As the electrochemical analysis device 4, a pH meter 43 that measures pH of the chemical solution is installed. In the chemical solution chamber S1, in addition to the analysis device 4, a flow meter (not illustrated) that measures a flow rate of the chemical solution flowing through the pipe, and a control valve 6 that controls a flow path and a flow rate of the chemical solution flowing through the pipe may be installed, or a pressure gauge that measures a pressure of the chemical solution flowing through the pipe may be installed.

In the electrical chamber S2, as the electrical device 3, for example, an electrical device for driving the analysis device 4, such as a power supply device, a transformer, an inverter, a switch that switches opening and closing of a drive circuit, a breaker that automatically interrupts the drive circuit when overcurrent or leakage occurs, or the like is installed. In addition to the electric device for driving the analysis device 4, various electrical devices may be installed in the electrical chamber S2.

In the electrical chamber S2, among the components of the analysis device 4 described above, a component that is unlikely to cause leakage of the chemical solution (for example, a light source included in the absorptiometer 41) may be installed. In this way, it is possible to reduce devices that get wet when leakage occurs in the chemical solution chamber S1.

Inside the component concentration measurement apparatus 100, an information processing device (not illustrated) that processes measurement information obtained from each analysis device 4 is provided. This information processing device calculates the concentration of the measurement target component in the chemical solution by using the light absorption spectrum (or absorbance spectrum) obtained by the analysis device 4 for optical measurement and the pH obtained by the pH meter 43. Note that the information processing device is a computer including an output unit such as a CPU, a memory, an input/output interface, an AD converter, and a display, and an input unit such as a keyboard, and the CPU and peripheral devices cooperate to function as a concentration calculator on the basis of a component concentration calculation program stored in the memory. Note that, a primary signal such as, for example, a voltage obtained from each analysis device 4 may be converted into, for example, an absorption spectrum, pH, and the like in the information processing device.

Thus, the component concentration measurement apparatus 100 is characterized by its housing structure so as to satisfy the standards of fire resistance and chemical resistance conforming to the SEMI standard. Hereinafter, the structure of a housing C will be described in detail.

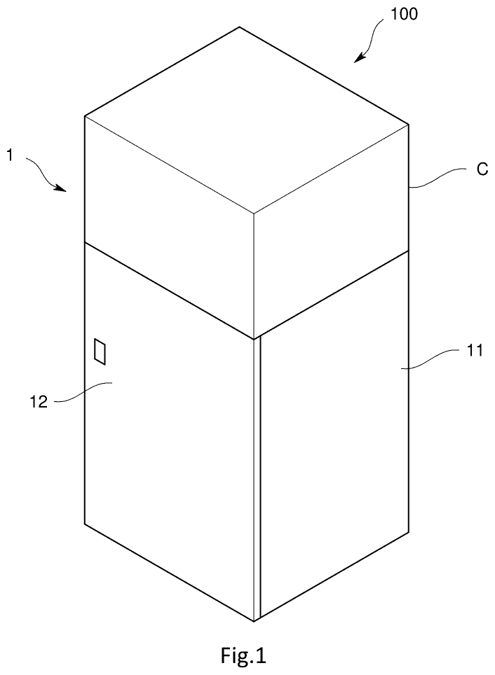

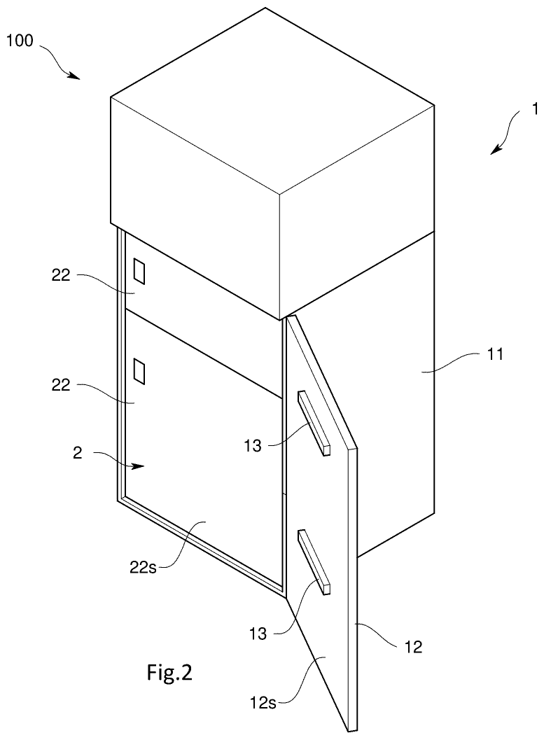

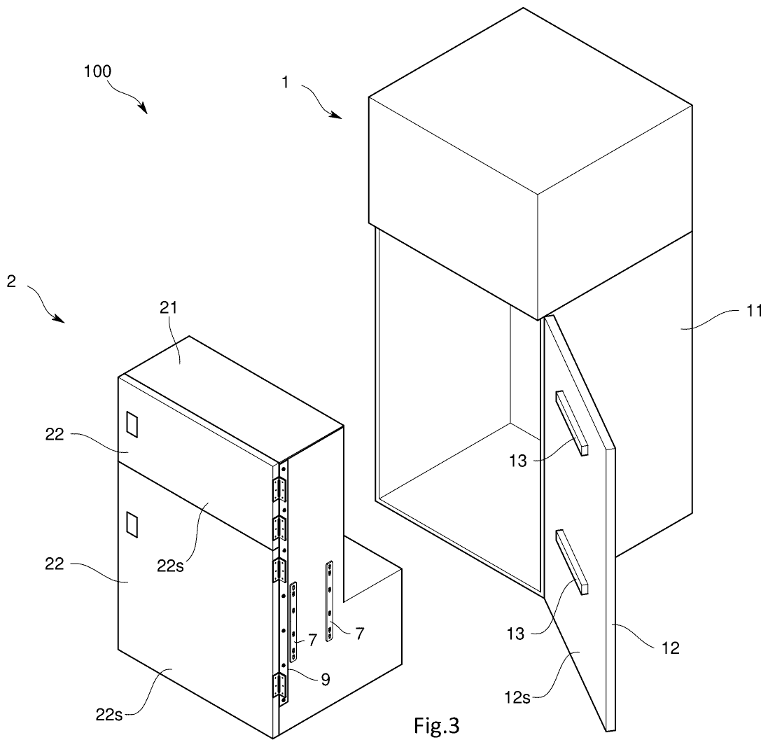

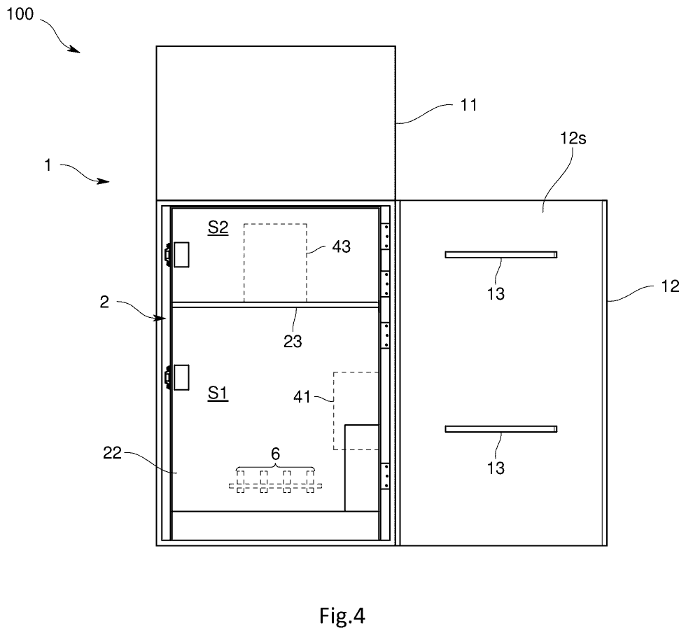

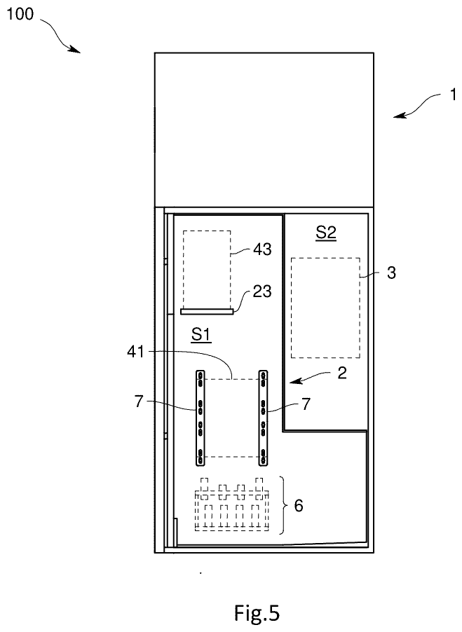

As illustrated in FIGS. 1 to 5, the component concentration measurement apparatus 100 has a double structure including a metal housing (hereinafter referred to as a metal housing 1) and a resin housing (hereinafter referred to as a resin housing 2) entirely accommodated in the metal housing 1. The electrical chamber S2 described above is provided inside the metal housing 1 and outside the resin housing 2, and the electrical device 3 described above is installed in a space outside the resin housing 2 inside the metal housing 1. On the other hand, the chemical solution chamber S1 is provided in the resin housing 2, and the chemical solution pipe, the analysis device 4, the flow meter, and the control valve 6 are installed in a space in the resin housing 2.

The metal housing 1 is an exterior of the component concentration measurement apparatus 100, and mainly includes a non-flammable material (specifically, for example, a metal material such as stainless steel). The metal housing 1 has a box shape with an accommodation space inside, and includes a housing body 11 (hereinafter also referred to as an outer housing) having an opening on a front surface, and an opening and closing door 12 (hereinafter also referred to as an outer door) that opens and closes the opening of the housing body 11. The opening and closing door 12 is of an open door type connected to the housing body 11 via a hinge which is an opening and closing mechanism.

The resin housing 2 forms the chemical solution chamber S1 with its inner wall surface, and the entire resin housing 2 includes a resin material having chemical resistance. The resin housing 2 according to the present embodiment includes polyvinyl chloride (PVC), but is not limited to this material as long as including a resin material having chemical resistance, and may include, for example, polypropylene (PP), fluororesin (PTFE), or the like. As the PVC constituting the resin housing 2, a PVC whose flame retardant grade is, although not necessarily, a normal grade (for example, a PVC conforming to V-0 of UL94 standard which is a flame retardant standard) is used.

The resin housing 2 has a box shape with an accommodation space inside, and includes a housing body 21 (hereinafter also referred to as an inner housing) having an opening on a front surface, and an opening and closing door 22 (hereinafter also referred to as an inner door) that opens and closes the opening of the housing body 21. The opening and closing door 22 is of an open door type connected to the housing body 21 via a hinge which is an opening and closing mechanism. The opening of the inner housing 21 is provided at a position corresponding to the opening of the outer housing 11, and has a double door structure in which the inner door 22 is exposed by opening the outer door 12.

The inner door 22 according to the present embodiment has a translucent region having translucency in a part or a whole of the inner door 22, and an operator can check an internal state through the translucent region without opening the inner door 22. The entire inner door 22 according to the present embodiment includes a resin material (for example, polypropylene, acrylic, and polycarbonate, although not necessarily) having translucency, and the entire inner door is a translucent region. In the present embodiment, the entire housing body 21 of the resin housing 2 includes an opaque resin material.

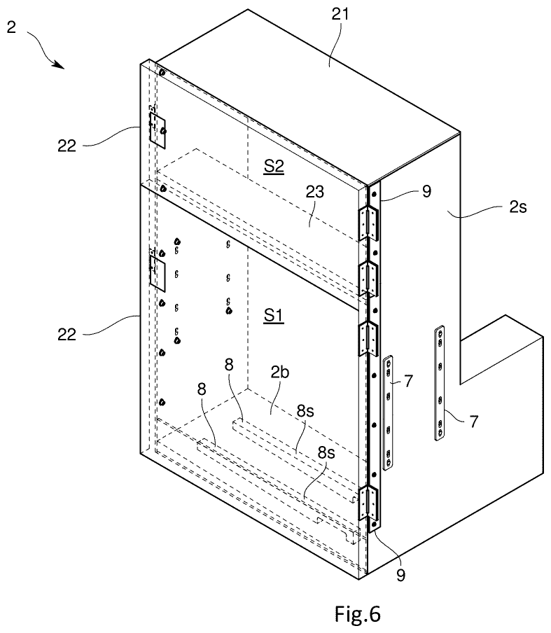

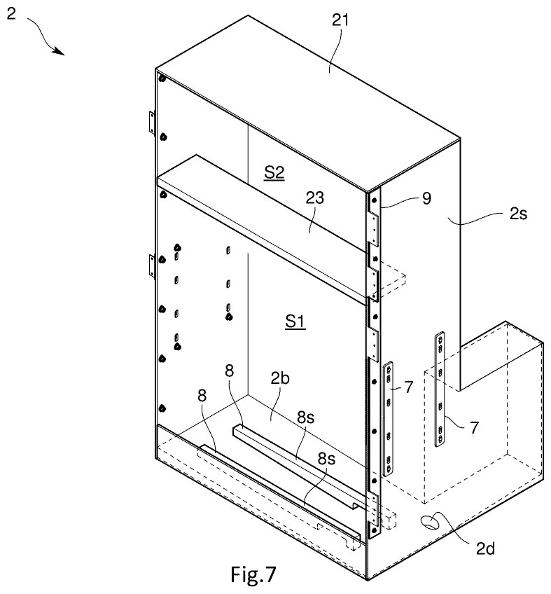

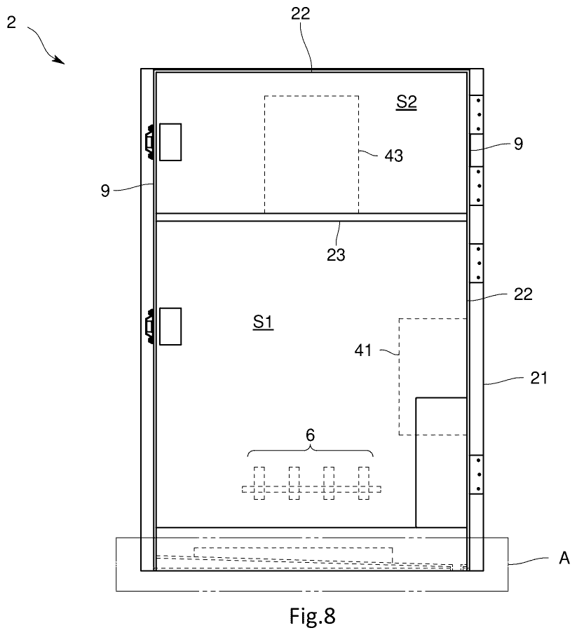

As illustrated in FIGS. 6 to 8, the resin housing 2 according to the present embodiment includes a plurality of inner doors 22, and the plurality of inner doors 22 closes the entire opening of the housing body 21. The resin housing 2 according to the present embodiment includes a shelf plate member 23 that at least partially partitions an internal space of the resin housing 2, and the internal space of the resin housing 2 is divided into two (upper and lower parts) by the shelf plate member 23. The resin housing 2 has the plurality of inner doors 22 so as to correspond to the respective spaces divided by the shelf plate member 23. In the present embodiment, the pH meter 43 is fixedly attached to a plate surface of the shelf plate member 23.

A plurality of support brackets 7 provided with a tap hole is attached to an outer surface 2s of the resin housing 2. Each of the support brackets 7 is for supporting the analysis device 4 installed in the resin housing 2, and is, for example, a metal plate including a metal material such as stainless steel. In a side wall of the resin housing 2, a through hole is formed at a position corresponding to the tap hole of each support bracket 7. Each analysis device 4 (specifically, a conductivity meter 42 and the absorptiometer 41) accommodated in the resin housing 2 is screwed into the tap hole of the support bracket 7 and supported. The through hole formed in the side wall of the resin housing 2 has a larger hole diameter than the tap hole of the support bracket 7, so that a load of the supported analysis device 4 is not applied to the through hole.

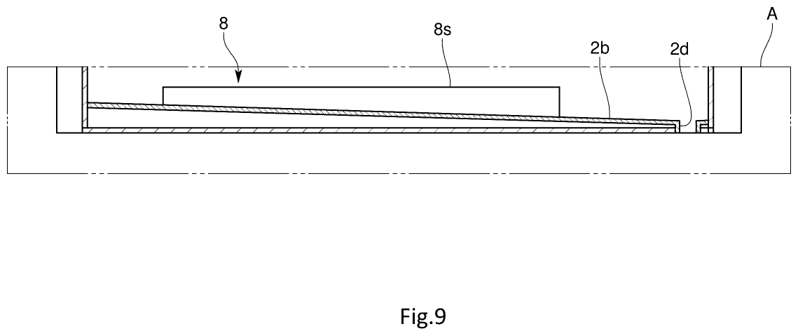

As illustrated in FIG. 9, an inclined surface is formed on a bottom surface 2b of the resin housing 2, and a drain port 2d is formed in a lower region of the inclined surface so that leakage can be drained when the chemical solution leaks in the resin housing 2. The inclined surface is formed so as to be inclined in a left-right direction. In the present embodiment, the inclined surface is formed all over the bottom surface 2b of the resin housing 2.

An attachment portion 8 having an upper surface 8s on which a horizontal attachment surface is formed is provided on the inclined surface of the bottom surface 2b of the resin housing 2. The attachment portion 8 has a block shape extending in the left-right direction. A plurality of control valves 6 is attached to the attachment surface of the attachment portion 8 side by side.

In the present embodiment, an inward surface 12s (that is, a surface facing the inner door 22) of the outer door 12 is provided with a protrusion 13 that protrudes toward an outward surface 22s of the inner door 22. The protrusion 13 is configured to come into contact with the outward surface 22s of the inner door 22 when the outer door 12 is closed, and when the outer door 12 is closed, the inner door 22 is pressed in a closing direction by the protrusion 13. The protrusion 13 according to the present embodiment is a ridge formed so as to extend in the left-right direction, and a plurality of the protrusions 13 is provided corresponding to the plurality of inner doors 22.

The resin housing 2 is provided with a holding mechanism that holds the inner door 22 in a closed state. The holding mechanism according to the present embodiment holds the inner door 22 by magnetic force, and is specifically configured by using a magnet catch. The holding mechanism includes a magnet attached to one of the housing body 21 or the inner door 22 of the resin housing 2, and a magnetic plate attached to the other one of the housing body 21 or the inner door 22.

In the present embodiment, a fixing bracket 9 is attached to the outer surface 2s of the resin housing 2, and the resin housing 2 is fixed to the metal housing 1 via the fixing bracket 9.

The fixing bracket 9 is an elongated metal plate including a metal material such as stainless steel, for example, and is attached to the vicinity of front sides on left and right side surfaces of the resin housing 2 so as to extend in an up-down direction. A tap hole is formed in the fixing bracket 9, and both left and right side walls of the resin housing 2 are screwed and fixed to both left and right side walls of the metal housing 1 via the tap hole.

The inner door 22 is not directly attached to the housing body 21 of the resin housing 2, but is attached to the fixing bracket 9. Specifically, a hinge that is an opening and closing mechanism is provided on the fixing bracket 9, and the inner door 22 is connected to the hinge. Furthermore, in the present embodiment, the magnet or the magnetic plate constituting the holding mechanism is also provided on the fixing bracket 9.

In the component concentration measurement apparatus 100 according to the present embodiment configured as described above, by installing the electrical device 3 that may cause ignition in the non-flammable metal housing 1, it is possible to satisfy the standard of fire resistance required by the SEMI standard. The resin housing 2 having chemical resistance is accommodated in the metal housing 1, and the chemical solution pipe and the analysis device 4 in which leakage of the chemical solution can occur are installed in the resin housing 2, and thus, the standard of chemical resistance can be satisfied.

Moreover, instead of satisfying the requirement for fire resistance and the requirement for chemical resistance by one housing, the requirement for fire resistance and the requirement for chemical resistance are satisfied by separate housings, a material cost can be suppressed and a manufacturing cost can be suppressed. That is, when both fire resistance and chemical resistance are to be satisfied by one resin housing 2, it is necessary to use expensive flame-retardant PVC. However, in the present invention, since the resin housing 2 only needs to satisfy the requirement for chemical resistance, for example, inexpensive normal grade PVC can be used. It is therefore possible to satisfy both requirements of chemical resistance and fire resistance while suppressing the material cost and the manufacturing cost.

Note that the present invention is not limited to the embodiment.

For example, in the embodiment, the opening and closing door 22 of the resin housing 2 includes, although not necessarily, a resin material having translucency. In another embodiment, the opening and closing door 22 of the resin housing 2 may include a material having no translucency, similarly to the housing body 21.

In the embodiment, the electrical device 3 is, although not necessarily, installed inside the metal housing 1 and outside the resin housing 2. In another embodiment, the electrical device 3 may also be installed in the resin housing 2.

In the embodiment, the support bracket 7 is, although not necessarily, attached to the outer surface 2s of the resin housing 2. In another embodiment, the support bracket 7 may be attached to an inner surface of the resin housing 2. In another embodiment, the analysis device 4 is, although not necessarily, screwed into the tap hole provided in the support bracket 7. The support bracket 7 is not required to be attached to the resin housing 2 according to another embodiment, and the analysis device 4 may be screwed and fixed to a tap hole formed in the side wall of the resin housing 2.

In another embodiment, the resin housing 2 may be directly fixed to the metal housing 1 without the fixing bracket 9 interposed therebetween.

The analysis device 4 installed in the resin housing 2 is not limited to the absorptiometer 41 and the pH meter 43. In another embodiment, instead of or in addition to the analysis devices, other analysis devices such as a conductivity meter, a dissolved oxygen meter, and a Raman measurement device may be installed in the resin housing 2. A plurality of the same analysis devices may be provided in the resin housing 2 so that the concentration of the chemical solution introduced from a plurality of different flow paths can be measured.

In addition, various modifications or combinations of the embodiments may be made without departing from the gist of the present invention.

### REFERENCE SIGNS LIST

100 component concentration measurement apparatus
1 metal housing
11 housing body (outer housing)
2 resin housing
3 electrical device
4 analysis device

What is claimed is:

1. A component concentration measurement apparatus that measures a concentration of a measurement target component in a chemical solution, the component concentration measurement apparatus comprising:
a metal housing; and
a resin housing accommodated in the metal housing, wherein
an electrical device that drives an analysis device is installed in the metal housing, the analysis device analyzing the chemical solution, and
a pipe through which the chemical solution flows and the analysis device are installed in the resin housing.

2. The component concentration measurement apparatus according to claim 1, wherein the electrical device is provided inside the metal housing and outside the resin housing.

3. The component concentration measurement apparatus according to claim 1, wherein
the metal housing and the resin housing each include an opening and closing door, and
the opening and closing door of the resin housing is provided with a translucent region.

4. The component concentration measurement apparatus according to claim 3, wherein the opening and closing door of the resin housing includes a translucent resin material.

5. The component concentration measurement apparatus according to claim 1, wherein
a protrusion protruding toward an outward surface of the opening and closing door of the resin housing is provided on an inward surface of the opening and closing door of the metal housing, and
when the opening and closing door of the metal housing is closed, the opening and closing door of the resin housing is pressed in a closing direction by the protrusion.

6. The component concentration measurement apparatus according to claim 5, further comprising a holding mechanism that holds the opening and closing door of the resin housing in a closed state.

7. The component concentration measurement apparatus according to claim 3, wherein the resin housing includes a plurality of the opening and closing doors.

8. The component concentration measurement apparatus according to claim 1, wherein
a fixing bracket is attached to an outer surface of the resin housing, and
the resin housing is fixed to the metal housing via the fixing bracket.

9. The component concentration measurement apparatus according to claim 8, wherein
the metal housing and the resin housing each include an opening and closing door,
the opening and closing door of the resin housing is provided with a translucent region, and
the opening and closing door of the resin housing is attached to the fixing bracket.

10. The component concentration measurement apparatus according to claim 1, wherein
a support bracket provided with a tap hole is attached to an outer surface of the resin housing,
a through hole is formed at a position corresponding to the tap hole on a side wall of the resin housing, and
the analysis device installed in the resin housing is screwed and supported in the tap hole of the support bracket.

11. The component concentration measurement apparatus according to claim 1, wherein
an inclined surface is formed on a bottom surface of the resin housing, and
a drain port is formed in a lower region of the inclined surface.

12. The component concentration measurement apparatus according to claim 11, wherein
the inclined surface is formed all over the bottom surface,
the inclined surface is provided with an attachment portion having an upper surface on which a horizontal attachment surface is formed, and
a control valve that controls a flow rate of the chemical solution is attached to the horizontal attachment surface.
